(19) United States
(12) Patent Application Publication
(10) Pub. No.: US 2007/0111677 A1
(43) Pub. Date: May 17, 2007

(54) Apparatus and method for stabilizing terminal power in a communication system

(75) Inventors: Patrick Claus Friedrich Eggers, Aalborg (DK); Gert Frolund Pedersen, Aalborg (DK); Mikael Bergholz Knudsen, Aalborg (DK); Do-Young Kim, Yongin-si (KR); Marcos Daniel Katz, Suwon-si (KR); Sung-Kwon Hong, Seoul (KR); Young-Kwon Cho, Suwon-si (KR); Jun-Young Jung, Yongin-si (KR); Dong-Seek Park, Yongin-si (KR); Chan-Byoung Chae, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/541,744

(22) Filed: Oct. 2, 2006

(30) Foreign Application Priority Data
Oct. 6, 2005 (KR) 94010-2005

(51) Int. Cl. H04B 1/02

(52) U.S. Cl. 455/101

(57) ABSTRACT

An apparatus and method are provided for stabilizing terminal power in antenna ports. A data transmission/reception method is provided for terminal power stabilization in a communication system using multiple antennas. An optimal antenna immune to absorption loss due to human body proximity is selected from among multiple antennas connected to a single port when a data service is provided. Data for the data service is transmitted and received through the selected antenna.

### PRIORITY

This application claims priority under 35 U.S.C. § 119 to an application filed in the Korean Intellectual Property Office on Oct. 6, 2005 and assigned Serial No. 2005-94010, the contents of which are incorporated herein by reference.

### BACKGROUND OF THE INVENTION

1. Field of the Invention

The present invention generally relates to an antenna apparatus and method for use in a communication system, and more particularly to an apparatus and method for stabilizing a terminal's power according to the choice of an antenna of a terminal in a communication system.

2. Description of the Related Art

Conventionally, the performance and capacity of a communication system are limited due to radio wave channel characteristics such as interference signals of the same channel occurring between cells or within a cell, path loss, multipath fading, signal delay, Doppler spreading, shadowing, and so on. To overcome the limitations in the performance and capacity, the communication system applies technologies of power control, channel coding, Rake reception, diversity antennas, cell sectoring, frequency division, band spreading, and so on.

Various communication service requests are increasing. However, existing technologies have great difficulty in providing high performance, large capacity services. A need exists for an image service system and high performance data for transmitting many packets and image signals. Thus, the communication system is being developed to provide multimedia communication services capable of high quality and large capacity. In terms of speech quality, high quality application services are being requested.

A large amount of research is being conducted on a communication system capable of satisfying the above-described requests. For example, research is being conducted on multi-antenna technology.

On the other hand, a typical communication system provides wireless communication between a base station and at least one mobile station or terminal. The base station is provided with an antenna device for transmitting a high frequency signal of a forward link to the mobile stations and receiving high frequency signals of reverse links from the mobile stations. Similarly, each of the mobile stations is provided with an antenna device for receiving a forward link signal and transmitting a reverse link signal.

Further, the mobile station applies power stabilization technology capable of determining the effect of short-term diversity and multiple-input multiple-output (MIMO) multiplexing gains with respect to the antenna device. The antenna technology based on power stabilization is the most direct and effective method for obtaining substantial gains in a communication transmission system.

The antenna technology based on power stabilization can obtain higher gains in comparison with modem, coding and algorithm technologies. Further, the antenna technology based on power stabilization can be easily implemented at low costs.

On the conventional small terminals or handsets, near-field disturbances cause absorption loss in the range of 0˜-10 dB in a single-antenna terminal. Thus, the communication system needs to stabilize the average power in the terminal to reduce the absorption loss. Conventionally, the absorption loss is power loss of a signal passing through an adjacent circuit or conductor in a communication circuit.

Next generation communication systems can provide one terminal with various services as well as power stabilization. When a user uses its terminal executing various applications such as game, video and call services, a problem may arise in that the electronic wave reception may be weak due to the user's hands or other adjacent devices near or around the antenna of the terminal. For example, when the user plays a game on the terminal, the user's hands may interfere with a received electronic wave depending on the antenna position. Thus, the strength of the electronic wave may change.

Therefore, a method is required which can satisfy the strength requirement of an electronic wave signal by considering the position or direction of the antenna so that a terminal can receive various services in the next generation communication systems. Further, a power stabilization method is required to smoothly provide services through an antenna system.

### SUMMARY OF THE INVENTION

Accordingly, the present invention has been designed to solve the above and other problems occurring in the prior art. Therefore, it is an object of the present invention to provide an apparatus and method that are immune to near-field absorption loss in a communication system.

It is another object of the present invention to provide an apparatus and method that can increase power stabilization and efficiency through immunization of near-field absorption loss in a terminal of a communication system.

It is another object of the present invention to provide an antenna apparatus and method that can provide optimal communication service through an optimal antenna immune to near-field absorption loss regardless of service type for a terminal in a communication system.

It is another object of the present invention to provide an antenna apparatus and method that can provide long-term and short-term diversity gains through passive combining in a communication system.

It is yet another object of the present invention to provide a power stabilization apparatus and method that can satisfy the strength requirement of an electronic wave signal by changing the position or direction of an antenna according to various services for a terminal in a communication system and that can stabilize terminal power in antenna ports of the terminal.

In accordance with an aspect of the present invention, there is provided an apparatus for stabilizing terminal power in a communication system using multiple antennas, including a predetermined number of antennas for providing data service in different positions with immunization of absorption loss due to a human body; a combiner for connecting the antennas and providing data signal transmission and reception paths according to the data service; and a transceiver, connected to the antennas through the combiner using a single port, for transmitting and receiving data signal.

In accordance with another aspect of the present invention, there is provided a data transmission/reception method for terminal power stabilization in a communication system using multiple antennas, including selecting an optimal antenna immune to absorption loss due to human body proximity from among multiple antennas connected to a single port when a data service is provided; and transmitting and receiving data for the data service through the selected antenna.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates an example of a structure of a terminal with three radiating elements in accordance with the present invention and illustrates an example of a parasitic antenna connected to a single transceiver port;

FIG. 2 illustrates an example of a multi-element test terminal in accordance with the present invention; and also illustrates an example of a monopole antenna in an antenna system in accordance with the present invention;

FIG. 3A is a performance graph of passive diversity for the total absorption loss moderately correlated in the antenna system in accordance with the present invention;

FIG. 3B is a performance graph of passive diversity for the total absorption loss moderately non-correlated in the antenna system in accordance with the present invention;

FIG. 3C is a performance graph of passive diversity for the total absorption loss moderately negative correlated in the antenna system in accordance with the present invention.

### DETAILED DESCRIPTION OF PREFERRED EMBODIMENTS

Preferred embodiments of the present invention will be described in detail herein below with reference to the accompanying drawings. In the following, detailed descriptions of functions and configurations incorporated herein that are well known to those skilled in the art are omitted for clarity and conciseness.

The present invention provides an apparatus and method that can stabilize terminal power in antenna ports of a terminal. The present invention discloses an antenna apparatus and method that can provide a more stable link budget, power stabilization and efficiency, impedance stabilization, and so on through immunization of near-field absorption loss. The present invention can obtain long-term diversity gain, i.e., average power diversity gain, and short-term diversity gain through passive combining in an antenna system.

Further, the present invention discloses an apparatus and method that can stabilize terminal power through immunization of absorption loss due to near-field disturbances when a terminal provides a data service in a communication system. In the present invention, when the terminal provides the data service, the position or direction of an antenna is considered for power stabilization and therefore the strength requirement of an electronic wave signal for providing the associated data service can be satisfied. In the present invention, an antenna operating in different bands is installed in one terminal. Thus, the terminal can receive signals transmitted in various bands when a different service operates at a center frequency.

The present invention discloses not only an antenna operating at different bands but also an antenna with the effect of vertical and horizontal polarizations in one terminal, such that various data services can be accommodated and power stabilization can be achieved for the data services. In the present invention, the antenna effects such as diversity and multiplexing can be variously selected according to antenna control in an antenna array.

As described above, the present invention discloses the apparatus and method for stabilizing terminal power in antenna ports of a terminal. Thus, the present invention can control the total average power loss due to dynamic near field loading.

The present invention does not need feedback information related to a channel state or interference of an antenna system by employing multiple radiating antennas covering the terminal. The present invention is distinct from the existing diversity technology for performing a combining or selection scheme using feedback information. That is, the present invention is passive diversity technology with a gain value in a predefined range according to system settings. In accordance with the present invention, antenna elements can eliminate the effect of the near-field disturbances.

In the present invention, power is distributed over all antenna elements. In this case, the different elements connect to a passive antenna network to redirect power from one antenna element to another. The passive antenna network can improve practical performance in the conventional multi-antenna technology and the standard antenna multiple-input multiple-output (MIMO) technology.

Conventionally, the standard antenna diversity and MIMO technologies select/combine antenna signals based on signal information. In terms of diversity or MIMO multiplexing gain, signal distribution, branch correlation and branch power difference (BPD) are important. In the following description, the BPD is not considered in the actual diversity/MIMO technology, but is crucial to obtain antenna diversity gain on the terminal subject to near field disturbances.

On the other hand, each antenna port of the terminal reduces simultaneous disturbances of the antenna elements and connects to an antenna system of several antenna elements passively connected. Thus, such a passive antenna system can provide higher probability that a diversity or MIMO operation may succeed. Thus, the link budget between different user handlings is stabilized and a variation in the efficiency of the terminal is reduced in a cellular network or other wireless networks.

In general, the terminal exhibits the average power loss due to near-field loading in the range of about 10˜20 dB. The average power has a difference of about 10 dB with respect to the general service handling, for example, voice service handling, and the same type of antenna. However, new terminals will provide various types of services, for example, voice, video and data services and the average power loss may vary more as users require various handlings.

To lower the risk for the complete radiating structure in the antenna system, the terminal should be immunized for user's actions creating dynamic near-field variations.

Immunization against near-field variations stabilizes the link budget, reduces the average power loss, and lengthens the battery lifetime of the terminal. The power distribution according to choice of an antenna section or antenna sub-elements lowers the power for the antenna elements, such that a specific absorption rate (SAR) related to the terminal is lowered.

An antenna type proposed in the present invention has a fixed antenna network without any need for information feedback of any signal state. The inventive technology can stabilize the average power related to the near-field influences when different users use the same terminal or the same user has different handling patterns (e.g., keyboard mode, talk or body position, video viewing, etc.) in the terminal.

For this, the present invention is designed to have a resonant element large enough. In the present invention, the design priority is to provide for surface coverage of a battery pack and to distribute the power over an antenna system where the antenna sub-elements can radiate independently of each other.

In the present invention, a discrete distributed system structure via an antenna network and a power splitter network are achieved. A circuit for discrete implementation is achieved with a single resonant structure. That is, the total radiating antenna system is distributed over several independent radiating elements placed such that they are not subject to the same degree of near-field loading. These elements can be passively combined with a combining network or similar. In the present invention, continuous implementation via continuous antenna elements is achieved.

Now, the structure and function of the present invention will be described with reference to the accompanying drawings.

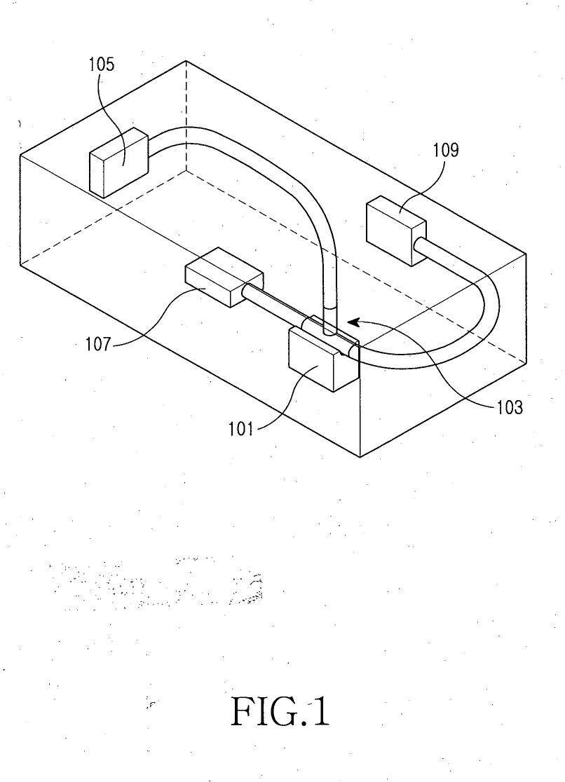

FIG. 1 illustrates an example of a structure of a terminal with three radiating elements in accordance with the present invention and illustrates an example of a parasitic antenna connected to a single transceiver port.

Referring to FIG. 1, an antenna system is provided with a transceiver 101, a combiner 103, and multiple antennas 105, 107, and 109. The antenna system has a single total radiating structure. Although not illustrated in FIG. 1, it is preferred that a baseband board for processing a signal and an antenna selector for selecting an antenna according to a predetermined control algorithm be included. An example in which the three antennas connect to the single transceiver port is illustrated in FIG. 1. Of course, at least two antennas as well as a single antenna can be configured according to a structure of the combiner 103.

Next, the operation of the above-described structure will be described.

In a higher layer of a terminal, the transmitting side for example, a base station transmits data. A service type of data is checked according to use of the user terminal. The antenna selector is notified of the service type.

Then, the antenna selector selects a predetermined antenna capable of minimizing absorption loss due to a human body of the user and performs optimal data communication when the data service is provided. The data communication is performed through the selected antenna. In this case, it is preferred that the antenna selector includes a predetermined antenna control algorithm for selecting an optimal antenna.

As illustrated in FIG. 1, the antenna system has a structure in which one port connects to the transceiver 101. This structure reduces the space of the total radiating structure compared with a single large radiator while at the same time having independent radiation for different sub-elements.

The combiner 103 is very simple and cheap. For example, the combiner 103 uses the conventional Wilkinson or 3 dB splitter. In a 2-branch case, the combiner 103 can be configured with two transmission lines of the length λ/4 and one isolation resistance component.

In accordance with the present invention, the antenna can be directional or omni-directional, and can have different polarizations.

The terminal can control operation of a horizontal or vertical antenna according to data service to be provided, thereby reducing antenna polarization loss. In other words, the present invention selects an optimized antenna for the type of service to be provided to the terminal. In this case, polarization control is performed such that the selected antenna operates as a horizontal or vertical polarized antenna according to communication environments. For example, the horizontal polarized antenna is selected for a horizontal service type and the vertical polarized antenna is selected for a vertical service type. Thus, the optimal antenna is selected which can minimize polarization loss.

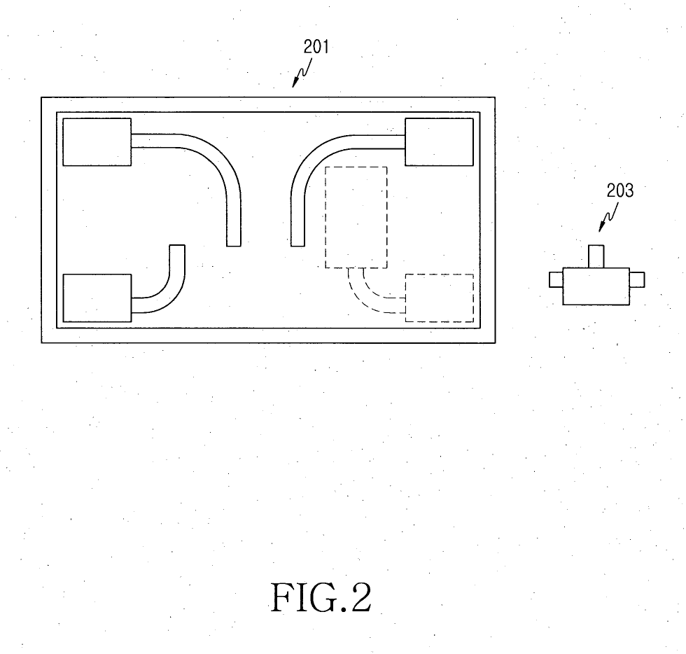

FIG. 2 illustrates an example of a small terminal 201 in which some antenna elements operate at 5 GHz and an example of a combining circuit 203. FIG. 2 illustrates an example of a monopole antenna in an antenna system in accordance with the present invention. As illustrated in FIG. 2, three antennas are provided. However, the present invention is not limited to the above-described structure, but is applicable to all configurations of antennas other than the monopole antenna of communication systems. In the preferred embodiment of the present invention, the combining circuit 203 connects to the three antennas. However, the present invention is not limited to the three-antenna structure, but can be applied to various forms and different number of antennas. As described above, the combining circuit 203 can employ the conventional power splitter.

The present invention uses the above-described total radiating structure for continuous power distribution instead of discrete sub-elements. The present invention better stabilizes total load matching in comparison with the case where a single resonant element is used. Next, the power stabilization, i.e., the immunization of the absorption loss, will be described.

The most important near-field effect for small terminals is the absorption loss due to body proximity or other lossy media. The load matching may not be affected to any greater degree as in an impedance change. When the same terminal and antenna are used for different user handling, the absorption loss typically varies in the range of 0˜10 dB. When user handling and different antenna types are considered, the spread of 0˜20 dB may be experienced.

Thus, distributing the sub-elements related to near-field loading may spread the risk of the absorption loss. However, the total radiating system may achieve stable average power and reduced loss probability. This plays an important role in providing the more stable link budget in a wireless cellular system and can reduce required average battery power. Thus, high gain is obtained in an active diversity or MIMO system.

Next, the immunization of load mismatch in accordance with the present invention will be described.

In the case of near-field disturbances by highly conductive materials (of metallic tables & shelves, metalized glass, cutlery, thermo cans, PC cabinets, and so on), the transceiver load conditions of standard antenna elements may change. In this case, the terminal transceiver becomes stable and can have an effective operating state of the antenna load through the immunization of the near-field effect.

That is, the antenna loads change within a factor 3 to 5 in a load range (from 10˜16.7 ohms to 150˜250 ohms in a 50-ohm system) according to antenna type and near-field effect. For example, a tolerable voltage standing wave ratio (VSWR) in cellular handsets has a maximum value of about 4. Thus, the present invention can increase the power efficiency of terminals and reduce the power requirements of battery supply of small terminals.

The performance in accordance the present invention will be described with reference to the accompany drawings.

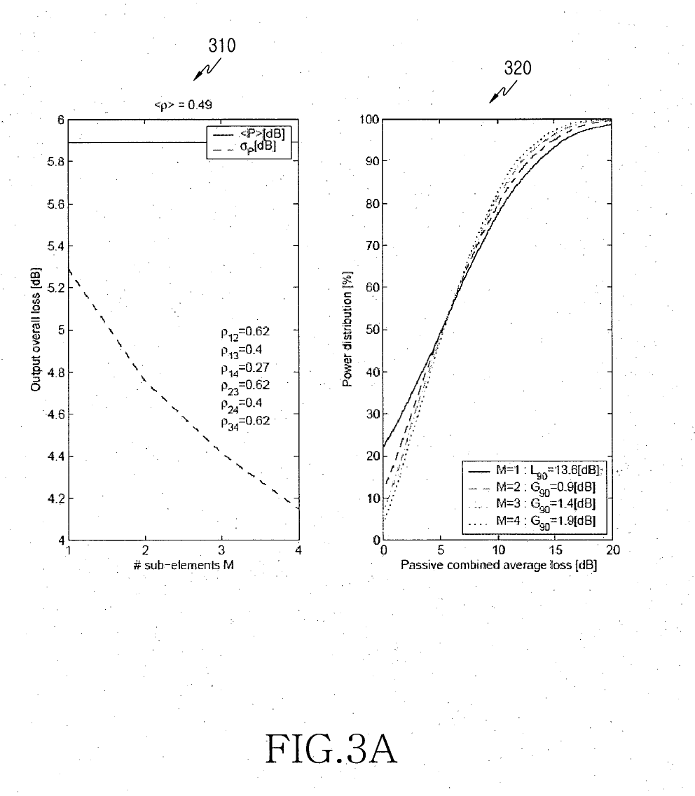

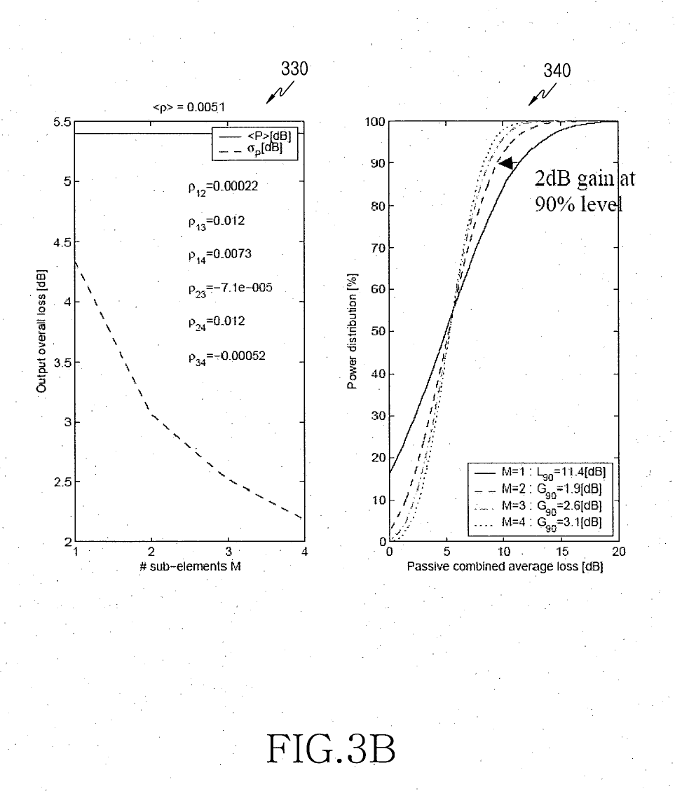

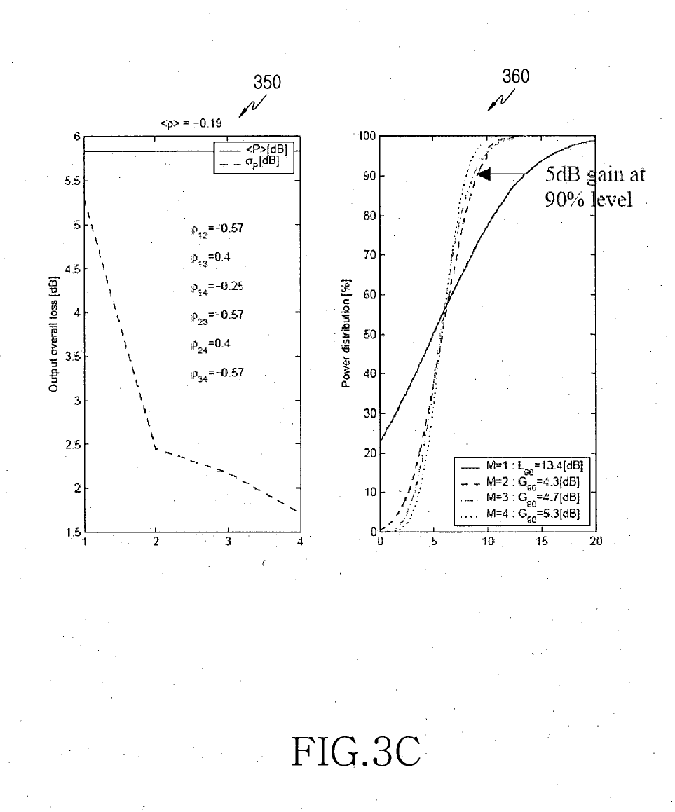

FIG. 3A is a performance graph of passive diversity for the total absorption loss moderately correlated in the antenna system in accordance with the present invention. FIG. 3B is a performance graph of passive diversity for the total absorption loss moderately non-correlated in the antenna system in accordance with the present invention. FIG. 3C is a performance graph of passive diversity for the total absorption loss moderately negative correlated in the antenna system in accordance with the present invention.

In FIGS. 3A to 3C, reference numerals 320, 340, and 360 denote the power stabilization gain and the absorption loss variation immunized by the present invention. In FIGS. 3A to 3C, reference numerals 310, 330, and 350 denote individual branch correlations. The absorption for sub-elements M has a simple model of the lognormal distributed loss with the mean value of 5 dB and the standard deviation of 5 dB. It can be seen that a loss distribution is between 0 dB and 20 dB over a total range through actual experimentation.

Next, results of the performance graphs as illustrated in FIGS. 3A to 3C will be described.

The steepness of the distribution increases along with an increase in the number of sub-elements and a decrease in the sub-element absorption loss correlation. That is, a decrease in the average power variation is equal to a decrease in the loss probability.

The global average power does not change, irrespective of the number of sub-elements or correlations. This is a consequence of a passive operation and is not related to a function for combining or selecting sub-element signals.

FIGS. 3A to 3C illustrate the case where the diversity gain increases up to 1˜4 dB at 90% level in two sub-elements (where M=2) with respect to 2 dB for the non-correlation absorption loss and a change from the positive correlation to the negative correlation. The 2 dB value constitutes a power reduction of 58% and battery power conservation at 90% level. Thus, the antenna system has an effective SAR.

In the non-correlated case of the standard deviation reduction and the average power variation, another benefit of the present invention is the compacting of the average loss variations through the standard deviation reduction from 4.5 dB to 3 dB using the setup of two sub-elements compared with a single element as indicated by reference numeral 330 of FIG. 3B. The steepness of the loss distribution (at 10˜90% level) has a range of about 11.5˜8 dB using two elements instead of one element as indicated by reference numeral 340 of FIG. 3B.

As described above, the performance graphs of the present invention illustrate the results obtained by employing measured absorption distributions and measured maximum impedance variations. These results are summarized as follows.

First, the performance of the power stabilization will be described.

In terms of the power stabilization effect in accordance with the present invention, the total absorption loss of a sub-element system is compared to that of a single antenna element system. The short-term diversity gain of about 5 dB is achievable at 90% level. For the non-correlated loading effects, the gain is about 2 dB at 90% level.

Next, the performance of the immunization of load mismatch will be described.

At very strong loading situations, the antenna impedance can change which can affect transceiver functionality/performance and combiner performance.

For example, in 2-branch simulations using a very simple standard 3 dB combiner, the antenna element impedance related to the stability of antenna load at the combined input using a single antenna element can be extended from 10˜25 ohms to 10˜250 ohms.

The present invention discloses a new passive antenna diversity scheme. A user's handling is typically stationary for a predetermined time period, for example, in a video game or phone conversation, which causes very poor average channel states if the absorption loss is not compensated for. In contrast, the antenna system of the present invention based on the passive antenna diversity scheme provides more stable average power through immunization of near-field disturbances, reduces the tail outage probability, and improves SAR. Further, the present invention, the average power per sub-element is de-correlated. The antenna system of the present invention can provide a more stable link budget and can conserve battery power on small terminals.

The present invention can stabilize impedance matching and can provide effective power transfer gain. Further, the present invention can stabilize average power in conjunction with active micro diversity or MIMO.

The features of the present invention can be summarized as follows.

(1) The present invention does not use control feedback of an antenna system. That is, the present invention avoids signal state feedback, which is different from the prior art.

(2) The present invention uses a fixed passive combination of independently radiating sub-elements, which is very easy and cheap to implement. The diversity effect is achieved via de-correlated blocking/loading of sub-elements due to user body proximity and other near-field disturbances.

(3) The present invention can achieve power stabilization even in long-term diversity that is not so well covered in the existing small terminals.

(4) The present invention has great potential in synergetic effect in a front-end system with a cascade combination of short-term diversity. Further, power can be equally distributed to establish ideal working conditions for a short-term antenna signal-processing scheme.

The antenna implementation of the present invention has a very simple structure because it uses printed antennas or patch antennas, and does not require any feedback or dynamic action from the terminal. Because an antenna at 5˜6 GHz has smaller antenna elements in comparison with an antenna at 2 GHz, there is no difficulty in placing or using several antenna elements on the smaller terminal.

As is apparent from the above description, an apparatus and method for stabilizing terminal power in a communication system can provide immunization of near-field absorption loss and can implement a more stable link budget and power stabilization. Moreover, the present invention can improve power efficiency and impedance stabilization through immunization of the near-field absorption loss. Moreover, the present invention can acquire average power diversity and short-term diversity through passive combining.

Although the preferred embodiments of the present invention have been disclosed for illustrative purposes, those skilled in the art will appreciate that various modifications, additions, and substitutions that are possible, without departing from the scope of the present invention. Therefore, the present invention is not limited to the above-described embodiments, but is further defined by the following claims, along with their full scope of equivalents.

What is claimed is:

1. An apparatus for stabilizing terminal power in a communication system using multiple antennas, comprising:
a predetermined number of antennas for providing a data service in different positions providing immunization to absorption loss due to a human body;
a combiner for connecting the antennas and providing data signal transmission and reception paths according to the data service ; and
a transceiver, connected to the antennas through the combiner using a single port, for transmitting and receiving a data signal.

2. The apparatus of claim 1, further comprising:
a discrete distributed structure, passively combined by the combiner, for reducing average power loss and impedance mismatch effects due to near-field loading effects.

3. The apparatus of claim 1, further comprising:
a continuous distributed structure, based on continuous antennas, for reducing average power loss and impedance mismatch effects due to near-field loading effects.

4. The apparatus of claim 1, wherein the combiner combines sub-elements for macro diversity.

5. The apparatus of claim 1, wherein the combiner has a combination structure for optimizing radiating efficiency by redirecting reflected power from one sub-element to another sub-element.

6. The apparatus of claim 1, wherein a combination pattern of the combiner is a cascade pattern mapped to short-term diversity and multiple-input multiple-output (MIMO).

7. A data transmission/reception method for terminal power stabilization in a communication system using multiple antennas, comprising the steps of:
selecting an optimal antenna immune to absorption loss due to human body proximity from among multiple antennas connected to a single port when a data service is provided; and
transmitting and receiving data for the data service through the selected antenna.
